(19) United States
(12) Patent Application Publication
(10) Pub. No.: US 2015/0323664 A1
(43) Pub. Date: Nov. 12, 2015

(54) MILLIMETER WAVE THREE DIMENSIONAL HOLOGRAPHIC SCAN IMAGING APPARATUS AND METHOD FOR INSPECTING A HUMAN BODY OR AN ARTICLE

(71) Applicant: Nuctech Company Limited, Beijing (CN)

(72) Inventors: Wanlong Wu, Beijing (CN); Zhiqiang Chen, Beijing (CN); Yuanjing Li, Beijing (CN); Ziran Zhao, Beijing (CN); Zongjun Shen, Beijing (CN); Yinong Liu, Beijing (CN); Bin Sang, Beijing (CN); Wenguo Liu, Beijing (CN)

(21) Appl. No.: 14/451,297

(22) Filed: Aug. 4, 2014

(30) Foreign Application Priority Data
Aug. 15, 2013 (CN) 201310356864.2

(51) Int. Cl. G01S 13/89; G01S 13/02

(52) U.S. Cl. CPC G01S 13/89; G01S 13/02

(57) ABSTRACT

A millimeter wave three dimensional holographic scan imaging apparatus and a method for inspecting a human body or an article are disclosed. In one aspect, the apparatus includes a first and second millimeter wave transceiver module. The apparatus also includes a guide rail device for each millimeter wave transceiver module. Each guide rail is connected to its respective transceiver module in slidable form. A driver drives each millimeter wave transceiver module to move along its guide rail device. Each millimeter wave transceiver module performs plane scans on the human body or article being inspected. A data processing device generates a millimeter wave holographic image from the plane scans.

### CROSS-REFERENCE TO RELATED APPLICATION

This application claims priority to Chinese Patent Application No. 201310356864.2 filed on Aug. 15, 2013, entitled “MILLIMETRE WAVE THREE DIMENSIONAL HOLOGRAPHIC SCAN IMAGING APPARATUS AND METHOD FOR INSPECTING A HUMAN BODY OR AN ARTICLE,” in the State Intellectual Property Office of China, the disclosure of which is incorporated herein by reference in its entirety.

### BACKGROUND OF THE INVENTION

1. Field of the Invention

The disclosed technology generally relates to human body security inspection, in particular to a millimeter wave three dimensional holographic scan imaging apparatus and a method for inspecting a human body or an article using the same.

2. Description of the Related Art

Inspection systems use X-ray, passive millimeter wave, or active millimeter wave imaging technology to inspect human bodies or articles (or, collectively, objects). For example, cylindrical scan imaging systems at, for example, airports, form holographic images using active millimeter wave imaging technology. Cylindrical scanners at airports are large and typically use a long vertical antenna array with many antennas, thereby increasing the cost of the scanner. Each passenger stands in a first position and is scanned by the single side scan imager that inspects one side of the passenger. The passenger turns so that the other side of the passenger can be scanned. Complex algorithms process the pair of cylindrical scans taken with the long vertical array of antennas to create holographic images.

There is a need to scan passengers more quickly, more efficiently, and at lower cost. This may be accomplished with millimeter wave three dimensional holographic imaging apparatus that do not require that the passenger move between scans, with scanners with smaller and less expensive planar arrays of antennas that take planar scans (and simpler algorithms), and that are more compact than existing cylindrical scanners.

### SUMMARY OF CERTAIN INVENTIVE ASPECTS

One object of certain embodiments of the disclosed technology is to provide a millimeter wave three dimensional holographic scan imaging apparatus that generates millimeter wave three dimensional holographic scan imaging rapidly and efficiently using planar scans with planar arrays of antennas, without requiring movement of the human body or object being inspected. A further object of the disclosed technology is to provide a method for inspecting a human body or an article using the millimeter wave three dimensional holographic scan imaging apparatus which can perform the inspection globally, conveniently and fast. It is in particular suitable to various applications of security inspection for a human body or an article.

To this end, the disclosed technology may be implemented by the following.

One aspect of the disclosed technology is a millimeter wave three dimensional holographic scan imaging apparatus, comprising:

a first millimeter wave transceiver module comprising a first millimeter wave transceiver antenna array for transmitting and receiving a first millimeter wave signal; a second millimeter wave transceiver module comprising a second millimeter wave transceiver antenna array for transmitting and receiving a second millimeter wave signal; a first guide rail device, to which the first millimeter wave transceiver module is connected in slid able form, such that the first millimeter wave transceiver module is moveable along the first guide rail device to perform a first scan on an object to be inspected; a second guide rail device, to which the second millimeter wave transceiver module is connected in slidable form, such that the second millimeter wave transceiver module is moveable along the second guide rail device to perform a second scan on the object to be inspected; and a driver configured to drive the first millimeter wave transceiver module to move along the first guide rail device and/or to drive the second millimeter wave transceiver module to move along the second guide rail device, wherein the first scan performed by the first millimeter wave transceiver module and the second scan performed by the second millimeter wave transceiver module both are plane scans.

For some embodiments, the first scan and the second scan may have a same direction or opposite directions.

For some embodiments, the first scan may have a direction which is parallel, perpendicular or inclined to that of the second scan.

For some further embodiments, the first millimeter wave transceiver module and/or the second millimeter wave transceiver module may move in a vertical direction.

For some embodiments, the first scan and the second scan may be performed synchronously or asynchronously.

For some embodiments, the first scan and the second scan may have different scan speeds.

For some embodiments, the driver may comprise a first driver configured to drive the first millimeter wave transceiver module directly, the first millimeter wave transceiver module being connected to the first guide rail device by the first driver, and/or the driver may comprise a second driver configured to drive the second millimeter wave transceiver module directly, the second millimeter wave transceiver module being connected to the second guide rail device by the second driver.

For some embodiments, the apparatus may further comprise a coupling means configured to allow the first millimeter wave transceiver module and the second millimeter wave transceiver module to move in association with each other, the driver being configured to drive the movements of the first millimeter wave transceiver module and the second millimeter wave transceiver module by driving at least one of the coupling means, the first millimeter wave transceiver module and the second millimeter wave transceiver module. In a further embodiment, the first guide rail device and/or the second guide rail device may be composed of one guide rail or a plurality of guide rails parallel to each other.

For some embodiments, the apparatus may further comprise: a data processing device communicated by wire or wireless to the first millimeter wave transceiver module and/or the second millimeter wave transceiver module to receive scan data from the first millimeter wave transceiver module and/or the second millimeter wave transceiver module and to generate a millimeter wave holographic image; and a display device communicated to the data processing device to receive and display the millimeter wave holographic image from the data processing device.

For some embodiments, the data processing device may be configured to generate a control signal and transmit it to the driver to allow the driver to drive the first millimeter wave transceiver module and/or the second millimeter wave transceiver module to move; or the millimeter wave three dimensional holographic scan imaging apparatus further comprises a separate controller with respect to the data processing device, the separate controller configured to generate a control signal and transmit it to the driver to allow the driver to drive the first millimeter wave transceiver module and/or the second millimeter wave transceiver module to move.

For some embodiments, the first millimeter wave signal and the second millimeter wave signal may have different frequencies in at least 50% of an entire period of scanning the object to be inspected by both the first millimeter wave transceiver module and the second millimeter wave transceiver module.

For some embodiments, the time at which the first millimeter wave transceiver antenna array transmits millimeter waves, may be different from the time at which the second millimeter wave transceiver antenna array transmits millimeter waves, during an entire period of scanning the object to be inspected by both the first millimeter wave transceiver module and the second millimeter wave transceiver module.

Another aspect of the disclosed technology is a method for inspecting a human body or an article using a millimeter wave three dimensional holographic scan imaging apparatus, comprising: locating the human body or the article at an inspection position and setting a first millimeter wave transceiver module and a second millimeter wave transceiver module at their scan beginning positions respectively; driving the first millimeter wave transceiver module and the second millimeter wave transceiver module by a driver to move from their scan beginning positions to their scan end positions along a first guide rail device and a second guide rail device continuously or discontinuously to achieve scanning to the human body or the article; transmitting data sampled by the first millimeter wave transceiver module and the second millimeter wave transceiver module during the scanning to a data processing device, in the scanning and/or after the scanning; and processing the data received from the first millimeter wave transceiver module and the second millimeter wave transceiver module using the data processing device to generate a millimeter wave holographic image of the human body or the article, wherein the scan performed by the first millimeter wave transceiver module and the scan performed by the second millimeter wave transceiver module both are plane scans.

For some embodiments, the scan performed by the first millimeter wave transceiver module and the scan performed by the second millimeter wave transceiver module may have different scan speeds.

For some embodiments, the first millimeter wave signal and the second millimeter wave signal may have different frequencies in at least 50% of an entire period of scanning the human body or the article by both the first millimeter wave transceiver module and the second millimeter wave transceiver module.

For some embodiments, the time at which the first millimeter wave transceiver antenna array transmits millimeter waves, may be different from the time at which the second millimeter wave transceiver antenna array transmits millimeter waves, during an entire period of scanning the human body or the article by both the first millimeter wave transceiver module and the second millimeter wave transceiver module.

For some embodiment, after generating the millimeter wave holographic image of the human body or the article, an automatic identification on whether the human body or the article entrains suspected objects and on the position of the suspected objects is carried out and the identified results are outputted.

Another aspect of the disclosed technology is a millimeter wave three dimensional holographic scan imaging apparatus. The apparatus includes a first millimeter wave transceiver module comprising a first millimeter wave transceiver antenna array configured to transmit and receive a first millimeter wave signal. The apparatus also includes a second millimeter wave transceiver module comprising a second millimeter wave transceiver antenna array configured to transmit and receive a second millimeter wave signal. The apparatus also includes a first guide rail device, to which the first millimeter wave transceiver module is connected in slidable form, such that the first millimeter wave transceiver module is moveable along the first guide rail device to perform a first scan on an object to be inspected. The apparatus also includes a second guide rail device, to which the second millimeter wave transceiver module is connected in slidable form, such that the second millimeter wave transceiver module is moveable along the second guide rail device to perform a second scan on the object to be inspected. The apparatus also includes a driver configured to drive the first millimeter wave transceiver module to move along the first guide rail device and/or the driver configured to drive the second millimeter wave transceiver module to move along the second guide rail device. The first scan and the second scan are plane scans.

Another aspect of the disclosed technology is a method for inspecting a human body or an article using a millimeter wave three dimensional holographic scan imaging apparatus. The method includes setting a first millimeter wave transceiver module at a first scan beginning position. The method also includes setting a second millimeter wave transceiver module at a second scan beginning position. The method also includes generating a first plane scan of the human body or the article by driving the first millimeter wave transceiver module from the first scan beginning position along a first guide rail device to a first scan end position, transmitting a first transmitted millimeter wave signal at a first scan rate, receiving a first received millimeter wave signal, and generating a first plurality of data samples in response to the first received millimeter wave signal. The method also includes generating a second plane scan of the human body or the article by driving the second millimeter wave transceiver module from the second scan beginning position along a second guide rail device to a second scan end position, transmitting a second transmitted millimeter wave signal at a second scan rate, receiving a second received millimeter wave signal and generating a second plurality of data samples in response to the second millimeter wave signal. The method also includes transmitting the first plurality of data samples and the second plurality of data samples to a data processing device. The method also includes generating a millimeter wave holographic image of the human body or article based on the first plurality of data samples and the second plurality of data samples.

Another aspect of the disclosed technology is a millimeter wave three dimensional holographic scan imaging apparatus. The apparatus includes means for transmitting and receiving a first millimeter wave signal. The apparatus also includes means for transmitting and receiving a second millimeter wave signal. The apparatus also includes means for moving in slidable form the first transmitting and receiving means to perform a first scan on an object to be inspected. The apparatus also includes means for moving in slidable form the second transmitting and receiving means to perform a second scan on the object to be inspected. The apparatus also includes means for driving the first transmitting and receiving means to move along the first moving means for moving in slidable form the first transmitting and receiving means and/or means for driving the second transmitting and receiving means to move along the second moving means for moving in slidable form the second transmitting and receiving means. The first scan and the second scan are plane scans.

On basis of at least one of the above aspects, a dual plane scan on the object to be inspected can be achieved by at least two millimeter wave transceiver modules. It can increase scan speeds, improve scan accuracy, simplify scan operations and enhance flexibility of the apparatus.

### BRIEF DESCRIPTION OF THE DRAWINGS

The solutions according to the disclosed technology will be described in detail with reference to the drawings, in which:

FIG. 1 shows an exemplary millimeter wave three dimensional holographic scan imaging apparatus according to an embodiment of the disclosed technology; and

FIGS. 2 and 3 are flowcharts illustrating methods for inspecting a human body or an article in accordance with the disclosed technology.

### DETAILED DESCRIPTION OF CERTAIN ILLUSTRATIVE EMBODIMENTS

Technical features and effects of the solutions according to the disclosed technology, which is directed to a millimeter wave three dimensional holographic scan imaging apparatus and a method for inspecting a human body or an article, will be explained in exemplary embodiments with reference to the attached drawings. It should be noted that similar reference numbers denote similar structures. The terms “first”, “second”, “upper”, and “lower” may be used in the present application for describing various structures of the device and various steps of the process. However, these words do not imply any spatial, sequential or hierarchy relation of various structures of the device and various steps of the process, unless the context clearly indicates otherwise.

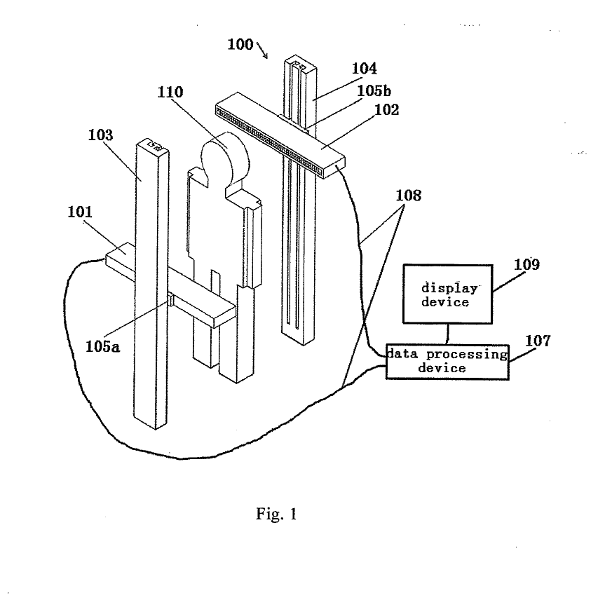

FIG. 1 shows an exemplary millimeter wave three dimensional holographic scan imaging apparatus 100 according to an embodiment of the disclosed technology. Apparatus 100 includes a first millimeter wave transceiver module 101, a second millimeter wave transceiver module 102, a first guide rail device 103, a second guide rail device 104 and drivers 105a, 105b. The first millimeter wave transceiver module 101 comprises a first millimeter wave transceiver antenna array for transmitting and receiving a first millimeter wave signal. The first millimeter wave transceiver module 101 is connected in slidable form to the first guide rail device 103, such that the first millimeter wave transceiver module 101 is moveable along the first guide rail device 103 to perform a first scan on an object 110 to be inspected. As such, the second millimeter wave transceiver module 102 comprises a second millimeter wave transceiver antenna array for transmitting and receiving a second millimeter wave signal and is connected in slidable form to the second guide rail device 104, such that the second millimeter wave transceiver module 102 is moveable along the second guide rail device 104 to perform a second scan on the object 110 to be inspected.

Accordingly, the millimeter wave three dimensional holographic scan imaging apparatus 100 may scan the object 110 using the first millimeter wave transceiver module 101 and the second millimeter wave transceiver module 102 at the same time, thereby inspecting two aspects or orientations of object 110 at the same time. For example, the millimeter wave three dimensional holographic scan imaging apparatus 100 may scan a front side and a back side of the object 110 (such as a human body or an article) at the same time. It can improve the inspection efficiency significantly, for example, when the object 110 to be inspected is the human body because the apparatus 100 can scan the front side and the back side of the human body at the same time without needing the human body to turn around. This increases inspection efficiency because, for example, there is no need for object 110 to change positions or turn around. The first scan performed by the first millimeter wave transceiver module 101 and the second scan performed by the second millimeter wave transceiver module 102 both are plane scans, instead of cylindrical scan. The millimeter wave holographic imaging algorithm required for the plane scans is simpler and more accurate than the algorithm for the cylindrical scans. Furthermore, plane scans may be performed in any scanning direction, such as the vertical, horizontal or inclined direction, while cylindrical scans are only performed along an arc-shaped track in the horizontal direction. Thus, dual plane scan arrangements, according to the disclosed technology, offer greater flexibility than is possible with cylindrical scans in the prior art.

For some implementations, the first millimeter wave transceiver module 101 and the second millimeter wave transceiver module 102 face each other as shown in FIG. 1. For some implementations, the first millimeter wave transceiver module 101 and the second millimeter wave transceiver module 102 are oriented at an angle to each other. For example, if a better imaging effect is desired to be achieved in a certain orientation (for example, the lateral frontal or rear orientation of the object 110 to be inspected, or the like), the first millimeter wave transceiver module 101 and the second millimeter wave transceiver module 102 may be arranged to not face to each other, but allowing the directions in which they transmit millimeter waves to be angled to each other.

The drivers 105a, 105b are configured to drive the first millimeter wave transceiver module 101 to move along the first guide rail device 103 and/or to drive the second millimeter wave transceiver module 102 to move along the second guide rail device 104. FIG. 1 shows a first driver 105a for driving the first millimeter wave transceiver module 101 directly and a second driver 105b for driving the second millimeter wave transceiver module 102 directly. However, all of these drivers are not necessary; for example, the millimeter wave three dimensional holographic scan imaging apparatus 100 may include only one of these drivers 105a and 105b. In case that more than one of drivers are provided, they may be operated separately or in combination as long as they can drive the first millimeter wave transceiver module 101 and/or the second millimeter wave transceiver module 102 to perform actions of scanning. In case that the above first driver 105a and/or second driver 105b are provided, the first millimeter wave transceiver module 101 may be connected to the first guide rail device 103 via the first driver 105a and/or the second millimeter wave transceiver module 102 may be connected to the second guide rail device 104 via the second driver 105b.

In an example, the first scan performed by the first millimeter wave transceiver module 101 and the second scan performed by the second millimeter wave transceiver module 102 may have a same direction. In such case, it is for example, easy to sample images of a same local portion of the object 110 to be inspected at various orientations more rapidly. As another example, the first scan performed by the first millimeter wave transceiver module 101 and the second scan performed by the second millimeter wave transceiver module 102 may have opposite directions. It may prevent the two modules facing to each other in most of period of scanning and thus the disturbance between the first millimeter wave transceiver module 101 and the second millimeter wave transceiver module 102 can be reduced.

Although the direction in which first millimeter wave transceiver module 101 performs the first scan is parallel to the direction in which second millimeter wave transceiver module 102 performs the second scan, in the example shown in FIG. 1, as appreciated by the skilled person in the art, it is not necessary. For example, the direction in which first millimeter wave transceiver module 101 performs the first scan may be perpendicular to or inclined to the direction in which second millimeter wave transceiver module 102 performs the second scan. As the millimeter wave transceiver antenna arrays in the first millimeter wave transceiver module 101 and the second millimeter wave transceiver module 102 have limited lengths, it is typically in practice desired to determine the scanning direction depending on the object to be scanned, in particular when the object is elongated, so as to take all advantage of the lengths of the millimeter wave transceiver antenna arrays as possible as we can, for cost consideration. For example, the directions of the first scan and the second scan may be arranged to be variable such that the user can adjust the scanning direction as desired. Such effects cannot be achieved by the cylindrical scans.

In an example, the first millimeter wave transceiver module 101 and/or the second millimeter wave transceiver module 102 may move in a vertical direction. It is especially advantageous for scanning upright human bodies. As an example, the first scan and the second scan may be performed synchronously, in order to emerge the three dimensional holographic image synchronously. However, they also may be performed asynchronously in consideration that the requirements to scan the object 110 may depend on its different sides to be scanned. For example, a certain side or local portion of the object 110 may need to be scanned finely while the remaining parts of the object 110 may need only a coarse scanning. In such circumstance, the first scan and the second scan may be controlled respectively in an asynchronous mode. Likewise, in an example, the first scan and the second scan may have different scan speeds to meet different requirements of scanning. Even the scan speeds of the first scan and the second scan may be varied continuously or intermittently.

In an example, millimeter wave three dimensional holographic scan imaging apparatus 100 may further comprise a coupling means configured to allow the first millimeter wave transceiver module 101 and the second millimeter wave transceiver module 102 to move in association with each other. For example, the coupling means may ensure that the first millimeter wave transceiver module 101 and the second millimeter wave transceiver module 102 move in the same speed or at a certain difference of speed, or it may keep a certain separation or phase difference between the first millimeter wave transceiver module 101 and the second millimeter wave transceiver module 102 on moving. As an example, the coupling means may be implemented as mechanical line or belt connecting the first millimeter wave transceiver module 101 and the second millimeter wave transceiver module 102. It also may constrain the first millimeter wave transceiver module 101 and the second millimeter wave transceiver module 102 by pneumatic, hydraulic, magnetic or electrostatic elements. It may be implemented even by constraints in the control signal of driving the first millimeter wave transceiver module 101 and the second millimeter wave transceiver module 102. The coupling means may not only constrain the movement of the first millimeter wave transceiver module 101 and the second millimeter wave transceiver module 102, but also improve their stability and reliability of the movements, even may provide a safe protection for them upon an accident occurs.

In case that the apparatus 100 comprises the coupling means, the driver may drive the movements of the first millimeter wave transceiver module 101 and the second millimeter wave transceiver module 102 by driving one or more of the coupling means, the first millimeter wave transceiver module 101 and the second millimeter wave transceiver module 102.

In an example, the first guide rail device 103 and the second guide rail device 104 may be substantially parallel to each other. For some implementations, they may be angled to each other for the sake of convenient arrangement. In an example, the first guide rail device 103 and/or the second guide rail device 104 may be composed of one guide rail or a plurality of guide rails parallel to each other. The latter allows the first millimeter wave transceiver module 101 and/or the second millimeter wave transceiver module 102 to move more stably.

In an example, the millimeter wave three dimensional holographic scan imaging apparatus 100 may further comprise a data processing device 107. The data processing device 107 is communicated by wire (for example by wires 108) or wireless to the first millimeter wave transceiver module 101 and/or the second millimeter wave transceiver module 102 to receive scan data from the first millimeter wave transceiver module 101 and/or the second millimeter wave transceiver module 102 and to generate a millimeter wave holographic image. The millimeter wave three dimensional holographic scan imaging apparatus 100 may further comprise a display device 109. The display device 109 is communicated to the data processing device 107 to receive and display the millimeter wave holographic image from the data processing device 107.

In an example, the data processing device 107 may be configured to generate a control signal and transmit it to the driver 105a, 105b to allow the driver 105a, 105b to drive the first millimeter wave transceiver module 101 and/or the second millimeter wave transceiver module 102 to move. As another example, the millimeter wave three dimensional holographic scan imaging apparatus 100 may also include a separate controller with respect to the data processing device 107, the separate controller configured to generate a control signal and transmit it to the drivers 105a, 105b to allow the drivers 105a, 105b to drive the first millimeter wave transceiver module 101 and/or the second millimeter wave transceiver module 102 to perform scanning motion.

In order to reduce the signal disturbance between the first millimeter wave transceiver module 101 and the second millimeter wave transceiver module 102, as an example, the first millimeter wave signal transmitted and received by the first millimeter wave transceiver module 101 and the second millimeter wave signal transmitted and received by the second millimeter wave transceiver module 102 may have different frequencies in at least 50% of an entire period of scanning the object 110 to be inspected by both the first millimeter wave transceiver module 101 and the second millimeter wave transceiver module 102, for example, in all of the entire period or in the part of the entire period in which the first millimeter wave transceiver module 101 is relatively close to the second millimeter wave transceiver module 102.

In another example, the time at which the first millimeter wave transceiver antenna array in the first millimeter wave transceiver module 101 transmits millimeter waves, may be different from the time at which the second millimeter wave transceiver antenna array in the second millimeter wave transceiver module 102 transmits millimeter waves, during the entire period of scanning the object 110 to be inspected by both the first millimeter wave transceiver module 101 and the second millimeter wave transceiver module 102, that is, the two modules transmit the respective millimeter waves at different times. It may also reduce or avoid the signal disturbance between the first millimeter wave transceiver module 101 and the second millimeter wave transceiver module 102.

As illustrated in FIG. 1, the object 110 to be inspected (the human body shown in FIG. 1) is located between the first millimeter wave transceiver module 101 and the second millimeter wave transceiver module 102. The first millimeter wave transceiver module 101 and the second millimeter wave transceiver module 102 may respectively perform scans on the front side and the back side of the object 110 to be inspected to obtain data and provide them to the data processing device 107 to generate millimeter wave images. For some implementations, the first millimeter wave transceiver module 101 and the second millimeter wave transceiver module 102 may perform scans on any sides of the object 110 to be inspected.

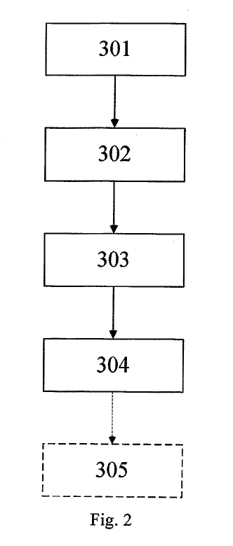

The disclosed technology further provides a method for inspecting a human body or an article using a millimeter wave three dimensional holographic scan imaging apparatus as described above, as shown in FIG. 2. The method includes: a step 301 of locating the human body or the article at an inspection position and setting a first millimeter wave transceiver module 101 and a second millimeter wave transceiver module 102 at their scan beginning positions respectively; a step 302 of driving the first millimeter wave transceiver module 101 and the second millimeter wave transceiver module 102 by drivers 105a, 105b to respectively move from their scan beginning positions to their scan end positions along the first guide rail device 103 and the second guide rail device 104 continuously or discontinuously to finish the scans to the human body or the article; a step 303 of transmitting data sampled by the first millimeter wave transceiver module 101 and the second millimeter wave transceiver module 102 during scanning to a data processing device 107, in scanning and/or after the scanning; and a step 304 of processing the data received from the first millimeter wave transceiver module 101 and the second millimeter wave transceiver module 102 using the data processing device 107 to generate a millimeter wave holographic image of the human body or the article.

In the above step 302, the scan performed by the first millimeter wave transceiver module 101 and the scan performed by the second millimeter wave transceiver module 102 both are plane scans.

As described above, during scanning of the first millimeter wave transceiver module 101 and the second millimeter wave transceiver module 102, the scan performed by the first millimeter wave transceiver module 101 and the scan performed by the second millimeter wave transceiver module 102 may have a same scan speed or different scan speeds.

In order to reduce the signal disturbance between the first millimeter wave transceiver module 101 and the second millimeter wave transceiver module 102, the frequency division (the first millimeter wave transceiver module 101 and the second millimeter wave transceiver module 102 transmit and receive millimeter waves by different frequencies) or the time division (the first millimeter wave transceiver module 101 and the second millimeter wave transceiver module 102 transmit millimeter waves at different times) as described above may be used in the step 302.

In an example, the above method may optionally further include a step 305 after generating the millimeter wave holographic image of the human body or the article, carrying out an automatic identification on whether the human body or the article entrains suspected objects and on the position of the suspected objects and outputting the identified results. Entrain is defined as to draw along with or after oneself, for example, a passenger entrains a suspect object if the object is hidden in the passenger's mouth or within the passenger's clothing. With the step 305, the suspected objects may be identified rapidly to avoid risks in security. It is in particular beneficial in applications which need to determine risks in security rapidly, for example, airports, and customs, and so on.

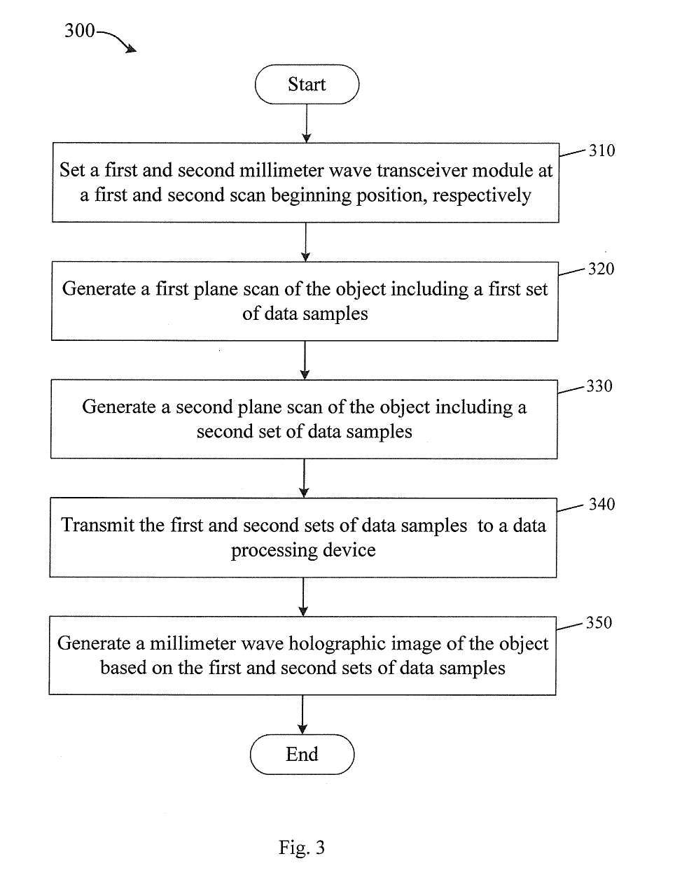

Inspecting a human body or an article using a millimeter wave three dimensional holographic scan imaging apparatus shown in FIG. 1 will now be described with respect to FIG. 3, which is a flowchart illustrating a method 300. At block 310, method 300 sets a first and second millimeter wave transceiver module at a first and second scan beginning position, respectively.

At block 320, method 300 generates a first plane scan of the object including a first set of data samples. At block 330, method 300 generates a second plane scan of the object including a second set of data samples.

At block 340, method 300 transmits the first and second sets of data samples to a data processing device. At block 350, method 300 generates a millimeter wave holographic image of the human body or article based on the first and second sets of data samples.

Although the disclosed technology has been explained with reference to the drawings, the embodiments shown in the drawings are only illustrative, instead of limiting the disclosed technology.

The present invention has been described above with reference to one or more embodiments thereof. It should be understood that various modifications, alternations and additions can be made to the device structure by one skilled person in the art without departing from the spirits and scope of the present invention. Moreover, the teachings of the present disclosure may make various modifications which may be adapted for particular situations or materials without departing from the spirits and scope of the present invention. Therefore, the object of the present invention is not limited to the above particular embodiments. The device structure and the manufacture method thereof as disclosed will include all of embodiments falling within the scope of the present invention. the scope of which is defined in the appended claims and their equivalents.

What is claimed is:

1. A millimeter wave three dimensional holographic scan imaging apparatus, comprising:
a first millimeter wave transceiver module comprising a first millimeter wave transceiver antenna array configured to transmit and receive a first millimeter wave signal;
a second millimeter wave transceiver module comprising a second millimeter wave transceiver antenna array configured to transmit and receive a second millimeter wave signal;
a first guide rail device, to which the first millimeter wave transceiver module is connected in slidable form, such that the first millimeter wave transceiver module is moveable along the first guide rail device to perform a first scan on an object to be inspected;
a second guide rail device, to which the second millimeter wave transceiver module is connected in slidable form, such that the second millimeter wave transceiver module is moveable along the second guide rail device to perform a second scan on the object to be inspected; and
a driver configured to drive the first millimeter wave transceiver module to move along the first guide rail device and/or the driver configured to drive the second millimeter wave transceiver module to move along the second guide rail device,
wherein the first scan and the second scan are plane scans.

2. The millimeter wave three dimensional holographic scan imaging apparatus of claim 1, wherein the first scan and the second scan have the same direction or opposite directions.

3. The millimeter wave three dimensional holographic scan imaging apparatus of claim 1, wherein the first scan has a direction which is parallel, perpendicular or inclined to that of the second scan.

4. The millimeter wave three dimensional holographic scan imaging apparatus of claim 1, wherein the first millimeter wave transceiver module and/or the second millimeter wave transceiver module move in a vertical direction.

5. The millimeter wave three dimensional holographic scan imaging apparatus of claim 1, wherein the first scan and the second scan are performed synchronously or asynchronously.

6. The millimeter wave three dimensional holographic scan imaging apparatus of claim 1, wherein the first scan and the second scan may have different scan speeds.

7. The millimeter wave three dimensional holographic scan imaging apparatus of claim 1, wherein the driver comprises a first driver configured to drive the first millimeter wave transceiver module directly, the first millimeter wave transceiver module being connected to the first guide rail device by the first driver, and/or the driver comprises a second driver configured to drive the second millimeter wave transceiver module directly, the second millimeter wave transceiver module being connected to the second guide rail device by the second driver.

8. The millimeter wave three dimensional holographic scan imaging apparatus of claim 1, wherein the millimeter wave three dimensional holographic scan imaging apparatus further comprises a coupling means configured to allow the first millimeter wave transceiver module and the second millimeter wave transceiver module to move in association with each other, the driver being configured to drive the movements of the first millimeter wave transceiver module and the second millimeter wave transceiver module by driving at least one of the coupling means, the first millimeter wave transceiver module and the second millimeter wave transceiver module.

9. The millimeter wave three dimensional holographic scan imaging apparatus of claim 1, wherein the first guide rail device and/or the second guide rail device is/are composed of one guide rail or a plurality of guide rails parallel to each other.

10. The millimeter wave three dimensional holographic scan imaging apparatus of claim 1, characterized in that the apparatus further comprises:
a data processing device configured to receive scan data from the first millimeter wave transceiver module and/or the second millimeter wave transceiver module, the data processing device further configured to generate a millimeter wave holographic image; and
a display device communicated to the data processing device to receive and display the millimeter wave holographic image from the data processing device.

11. The millimeter wave three dimensional holographic scan imaging apparatus of claim 10, wherein the data processing device is configured to generate a control signal and transmit it to the driver to allow the driver to drive the first millimeter wave transceiver module and/or the second millimeter wave transceiver module to move; or the millimeter wave three dimensional holographic scan imaging apparatus further comprises a separate controller with respect to the data processing device, the separate controller configured to generate a control signal and transmit it to the driver to allow the driver to drive the first millimeter wave transceiver module and/or the second millimeter wave transceiver module to move.

12. The millimeter wave three dimensional holographic scan imaging apparatus of claim 1, wherein the first millimeter wave signal and the second millimeter wave signal have different frequencies in at least 50% of an entire period of scanning the object to be inspected by both the first millimeter wave transceiver module and the second millimeter wave transceiver module.

13. The millimeter wave three dimensional holographic scan imaging apparatus of claim 1, wherein the time at which the first millimeter wave transceiver antenna array transmits millimeter waves, is different from the time at which the second millimeter wave transceiver antenna array transmits millimeter waves, during an entire period of scanning the object to be inspected by both the first millimeter wave transceiver module and the second millimeter wave transceiver module.

14. A method for inspecting a human body or an article using a millimeter wave three dimensional holographic scan imaging apparatus, comprising:
setting a first millimeter wave transceiver module at a first scan beginning position;
setting a second millimeter wave transceiver module at a second scan beginning position;
generating a first plane scan of the human body or the article by driving the first millimeter wave transceiver module from the first scan beginning position along a first guide rail device to a first scan end position, transmitting a first transmitted millimeter wave signal at a first scan rate, receiving a first received millimeter wave signal, and generating a first plurality of data samples in response to the first received millimeter wave signal;
generating a second plane scan of the human body or the article by driving the second millimeter wave transceiver module from the second scan beginning position along a second guide rail device to a second scan end position, transmitting a second transmitted millimeter wave signal at a second scan rate, receiving a second received millimeter wave signal, and generating a second plurality of data samples in response to the second millimeter wave signal;
transmitting the first plurality of data samples and the second plurality of data samples to a data processing device; and
generating a millimeter wave holographic image of the human body or article based on the first plurality of data samples and the second plurality of data samples.

15. The method of claim 14, wherein the first scan rate is greater than the second scan rate.

16. The method of claim 14, wherein a first frequency of the first transmitted millimeter wave signal is different from a second frequency of the second transmitted millimeter wave signal for at least 50% of an entire period of time when generating the first plane scan and generating the second plane scan occur simultaneously.

17. The method of claim 14, wherein the time at which the first millimeter wave transceiver antenna array transmits millimeter waves, is different from the time at which the second millimeter wave transceiver antenna array transmits millimeter waves, during an entire period of scanning the human body or the article by both the first millimeter wave transceiver module and the second millimeter wave transceiver module.

18. The method of claim 14, further comprising:
detecting whether the human body or the article entrains a suspected object; and
identifying the position of the suspected object.

19. A millimeter wave three dimensional holographic scan imaging apparatus, comprising:
means for transmitting and receiving a first millimeter wave signal;
means for transmitting and receiving a second millimeter wave signal;
means for moving in slidable form the first transmitting and receiving means to perform a first scan on an object to be inspected;
means for moving in slidable form the second transmitting and receiving means to perform a second scan on the object to be inspected;
means for driving the first transmitting and receiving means to move along the first moving means for moving in slidable form the first transmitting and receiving means and/or means for driving the second transmitting and receiving means to move along the second moving means for moving in slidable form the second transmitting and receiving means,
wherein the first scan and the second scan are plane scans.

20. The apparatus of claim 19, wherein the first transmitting and receiving means comprises a first millimeter wave transceiver module comprising a first millimeter wave transceiver antenna array, wherein the second transmitting and receiving means comprises a second millimeter wave transceiver module comprising a second millimeter wave transceiver antenna array, wherein the first moving means comprises a first guide rail device, wherein the second moving means comprises a second guide rail device, and wherein the means for driving the first transmitting and receiving means and/or driving the second transmitting and receiving means comprises a driver.
